(19) United States
(12) Patent Application Publication
(10) Pub. No.: US 2018/0216467 A1
(43) Pub. Date: Aug. 2, 2018

(54) TURBINE ENGINE WITH AN EXTENSION INTO A BUFFER CAVITY

(71) Applicant: General Electric Company, Schenectady, NY (US)

(72) Inventors: Brian Kenneth Corsetti, Reading, MA (US); Christopher Michael Ceglio, Boston, MA (US); Robert Francis Manning, Newburyport, MA (US)

(21) Appl. No.: 15/422,597

(22) Filed: Feb. 2, 2017

(51) Int. Cl. F01D 5/08; F01D 25/12; F01D 9/02; F01D 11/02; F04D 19/02; F04D 29/08; F04D 29/32; F04D 29/58; F02K 3/06

(52) U.S. Cl. CPC F01D 5/082; F01D 25/12; F01D 9/02; F01D 11/02; F04D 19/02; F04D 29/083; F05D 2260/2212; F04D 29/582; F02K 3/06; F05D 2220/32; F05D 2240/30; F05D 2240/55; F05D 2260/2214; F04D 29/322

(57) ABSTRACT

A turbine engine, such as a gas turbine engine for an aircraft, can include a compressor section, a combustion section, and a turbine section in axial arrangement. The compressor and turbine sections can include a rotating disk having a plurality of blades and a stationary band having a plurality of stationary vanes. The disk and band are spaced axially defining a buffer cavity. One or more extensions extend into the buffer cavity to prevent ingestion of heated gas into the buffer cavity. Recesses on the underside of the extensions can improve the heat transfer coefficient for the extensions.

### BACKGROUND OF THE INVENTION

Turbine engines, and particularly gas or combustion turbine engines, are rotary engines that extract energy from a flow of combusted gases passing through the engine in a series of compressor stages, which include pairs of rotating blades and stationary vanes, through a combustor, and then onto a multitude of turbine blades. In the compressor stages, the blades are supported by posts protruding from the rotor while the vanes are mounted to stator disks. Gas turbine engines have been used for land and nautical locomotion and power generation, but are most commonly used for aeronautical applications such as for airplanes, including helicopters. In airplanes, gas turbine engines are used for propulsion of the aircraft.

Gas turbine engines for aircraft are designed to operate at high temperatures to maximize engine thrust, so cooling of certain engine components, such as the rotor post is necessary during operation. Typically, cooling is accomplished by ducting cooler air from the high and/or low pressure compressors to the engine components which require cooling.

In adjacent compressor stages, there is a tendency for the pressure across the adjacent stages to want to back flow through a seal with the vanes, leading to additional heating of the rotor post of an upstream compressor stage, which, under the certain thermal conditions, can lead to the temperature at the upstream rotor post exceeding its creep temperature resulting unwanted creeping of the rotor post. This is especially true for the most rearward or aft compressor stage, which is subject to the greatest temperature.

### BRIEF DESCRIPTION OF THE INVENTION

In one aspect, the disclosure relates to a disk assembly for a turbine engine defining an engine centerline extending axially between a forward end and an aft end of the turbine engine. The disk assembly includes a disk rotatable about the engine centerline having disk sidewalls and having a platform as a radially exterior surface of the disk with the platform having an extension with an underside and extending axially beyond at least one disk sidewall. The disk assembly includes a plurality of recesses formed on the underside of the platform.

In another aspect, the disclosure relates to a turbine engine having a working air flow including a stator having a working surface over which the working air flow passes and a rotor rotating relative to the stator being spaced from the stator defining a buffer cavity and having a working surface over which the working air flow passes. A disk forms at least a portion of the rotor and includes a plurality of circumferentially arranged blades and includes a platform having an extension extending over the buffer cavity with the extension having an underside. A plurality of recesses are formed on the underside of the platform.

In yet another aspect, the disclosure relates to a method of lowering metal temperatures of an extension extending into a buffer cavity between a rotor and a stator of a turbine engine, the method including providing a plurality of recesses on an underside of the extension, wherein the recesses increase the heat transfer coefficient on the underside of the extension while maintaining or minimizing a required effective clearance between the extension and an adjacent surface.

### BRIEF DESCRIPTION OF THE DRAWINGS

In the drawings:

FIG. 1 is a schematic, sectional view of a gas turbine engine.

FIG. 2 is a section view of a turbine section of the gas turbine engine of FIG. 1.

FIG. 3 is an enlarged view of a buffer cavity between a disk and a ring of the turbine section of FIG. 2 having three extensions.

FIG. 4 is a perspective view of an underside of an extension shown as a platform including a plurality of recesses.

FIG. 5 is a cross-sectional view of the platform of FIG. 4 showing non-hemispherical profiles for the recesses.

FIG. 6 is a perspective view of an underside of another extension including a plurality recesses formed as troughs.

FIG. 7 is a perspective view of an underside of yet another extension including a plurality of alternating recesses and turbulators.

### DESCRIPTION OF EMBODIMENTS OF THE INVENTION

The described embodiments of the present invention are directed to cooling recesses provided on extensions extending into a buffer cavity between the rotor and stator elements in a turbine engine and a method of lowering operational temperatures of such an extension. For purposes of illustration, the present invention will be described with respect to an aircraft gas turbine engine, and more particularly, a rotor disk having a plurality of circumferentially spaced airfoil blades. It will be understood, however, that the invention is not so limited and may have general applicability in non-aircraft applications, such as other mobile applications and non-mobile industrial, commercial, and residential applications, as well as other turbine engines and applicability to other areas of a turbine engine outside that of a turbine rotor disk.

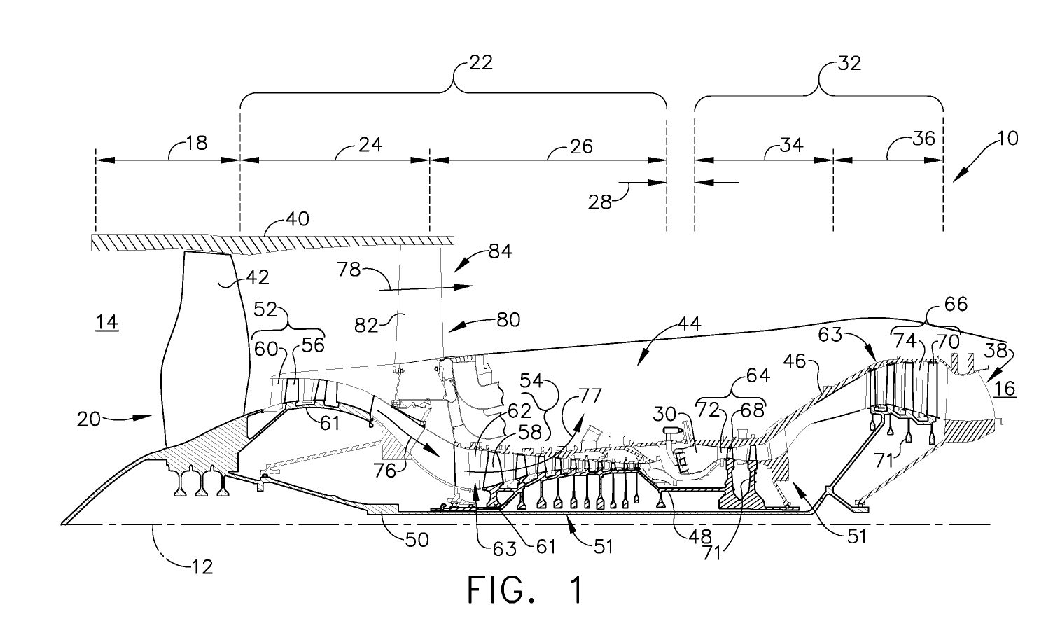

FIG. 1 is a schematic cross-sectional diagram of a gas turbine engine 10 for an aircraft. The engine 10 has a generally longitudinally extending axis or centerline 12 extending from a forward end 14 to an aft end 16. The engine 10 includes, in downstream serial flow relationship, a fan section 18 including a fan 20, a compressor section 22 including a booster or low pressure (LP) compressor 24 and a high pressure (HP) compressor 26, a combustion section 28 including a combustor 30, a turbine section 32 including a HP turbine 34, and a LP turbine 36, and an exhaust section 38.

The fan section 18 includes a fan casing 40 surrounding the fan 20. The fan 20 includes a plurality of fan blades 42 disposed radially about the centerline 12. The HP compressor 26, the combustor 30, and the HP turbine 34 form a core 44 of the engine 10, which generates combustion gases. The core 44 is surrounded by core casing 46, which can be coupled with the fan casing 40.

A HP shaft or spool 48 disposed coaxially about the centerline 12 of the engine 10 drivingly connects the HP turbine 34 to the HP compressor 26. A LP shaft or spool 50, which is disposed coaxially about the centerline 12 of the engine 10 within the larger diameter annular HP spool 48, drivingly connects the LP turbine 36 to the LP compressor 24 and fan 20. The portions of the engine 10 mounted to and rotating with either or both of the spools 48, 50 are also referred to individually or collectively as a rotor 51.

The LP compressor 24 and the HP compressor 26 respectively include a plurality of compressor stages 52, 54, in which a set of compressor blades 58 rotate relative to a corresponding set of static compressor vanes 60, 62 (also called a nozzle) to compress or pressurize the stream of fluid passing through the stage. In a single compressor stage 52, 54, multiple compressor blades 56, 58 can be provided in a ring and can extend radially outwardly relative to the centerline 12, from a blade platform to a blade tip, while the corresponding static compressor vanes 60, 62 are positioned downstream of and adjacent to the rotating blades 56, 58. It is noted that the number of blades, vanes, and compressor stages shown in FIG. 1 were selected for illustrative purposes only, and that other numbers are possible. The blades 56, 58 for a stage of the compressor can be mounted to a disk 53, which is mounted to the corresponding one of the HP and LP spools 48, 50, with each stage having its own disk. The vanes 60, 62 are mounted to the core casing 46 in a circumferential arrangement about the rotor 51.

The HP turbine 34 and the LP turbine 36 respectively include a plurality of turbine stages 64, 66, in which a set of turbine blades 68, 70 are rotated relative to a corresponding set of static turbine vanes 72, 74 (also called a nozzle) to extract energy from the stream of fluid passing through the stage. In a single turbine stage 64, 66, multiple turbine blades 68, 70 can be provided in a ring and can extend radially outwardly relative to the centerline 12, from a blade platform to a blade tip, while the corresponding static turbine vanes 72, 74 are positioned upstream of and adjacent to the rotating blades 68, 70. It is noted that the number of blades, vanes, and turbine stages shown in FIG. 1 were selected for illustrative purposes only, and that other numbers are possible.

In operation, the rotating fan 20 supplies ambient air to the LP compressor 24, which then supplies pressurized ambient air to the HP compressor 26, which further pressurizes the ambient air. The pressurized air from the HP compressor 26 is mixed with fuel in the combustor 30 and ignited, thereby generating combustion gases. Some work is extracted from these gases by the HP turbine 34, which drives the HP compressor 26. The combustion gases are discharged into the LP turbine 36, which extracts additional work to drive the LP compressor 24, and the exhaust gas is ultimately discharged from the engine 10 via the exhaust section 38. The driving of the LP turbine 36 drives the LP spool 50 to rotate the fan 20 and the LP compressor 24.

Some of the ambient air supplied by the fan 20 can bypass the engine core 44 and be used for cooling of portions, especially hot portions, of the engine 10, and/or used to cool or power other aspects of the aircraft. In the context of a turbine engine, the hot portions of the engine are normally downstream of the combustor 30, especially the turbine section 32, with the HP turbine 34 being the hottest portion as it is directly downstream of the combustion section 28. Other sources of cooling fluid can be, but is not limited to, fluid discharged from the LP compressor 24 or the HP compressor 26.

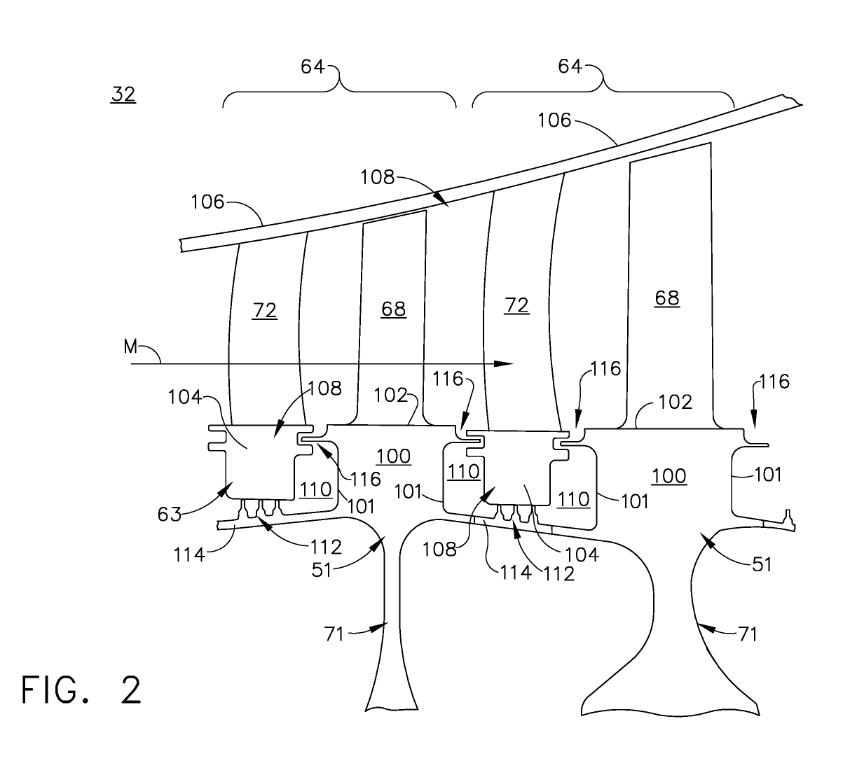

FIG. 2 illustrates a portion of the turbine section 32 including at least one disk assembly including a disk 71 which can form a portion of the rotor 51 (FIG. 1) as a rotating component. The rotating component can include any rotating element making up the rotor 51, for example. The disk assembly can include a dovetail 100, while it is contemplated that the disk can be a blisk, having no dovetail. The dovetail 100 can include sidewalls 101 at opposing axial sides of the dovetail 100. In the example where the disk 71 is a blisk having no dovetail, the sidewalls 101 can be sidewalls 101 of the disk 71 as opposed to the dovetail 100. The blades 68 couple to the disk 71 or the dovetail 100 at a platform 102. The platform 102 can be the radially exterior surface of the disk 71 or dovetail 100. The disk 71 rotates about the centerline 12 (FIG. 1), rotating the dovetail 100, platform 102, and the blades 68 circumferentially about the centerline 12.

A stationary component, such as the vanes 72, or any component as part of the stator 63, can be positioned upstream of the blades 68 to form the HP turbine stages 64 with the adjacent downstream blade 68. The vanes 72 mount between an inner band 104 and a radially outer band 106, relative to the engine centerline 12 (FIG. 1). The inner band 104 and the outer band 106 can collectively form a ring 108. The vanes 72 and rings 108 mounting the vanes 72 can be stationary, forming at least a portion of the stator 63 (FIG. 1). A buffer cavity 110 can be defined between adjacent rotor 51 and stator 63 elements, such as between the inner band 104 and the dovetail 100. A radial seal 112 can mount to a portion 114 of the rotor 51 extending between adjacent disks 71. A mainstream airflow M can pass in a substantially axial direction through the stages 64, driven by the blades 68. The rotor 51 and stator 63 elements can have a working surface confronting the mainstream working airflow M, where the stator 63 can define a first working surface and the rotor 51 can define a second working surface. During operation, there can be a tendency for the mainstream airflow M to ingest between adjacent disks 71 and rings 108 into the buffer cavities 110 due to pressure differentials at different positions along the engine. Such ingestion can lead to leakage of the mainstream airflow M among different stages 64, which can reduce efficiency of the engine. Despite the radial seals 112, a portion of the ingested airflow is permitted to leak to downstream stages.

Additionally, the ingested mainstream airflow M can cause unwanted heating of inboard portions of the rotor 51 and stator 63, without leaking between stages 64. In order to prevent ingestion, one or more extensions 116 can extend from the disk 71 or the ring 108, such as extending from the inner band 104 and the dovetail 100. Alternatively, the extension 116 can be the platform 102, where the portion of the platform 102 extending axially beyond the sidewalls 101 can define the extension 116. Additionally a length for the extension 116 as the platform 102 can be the length of the platform extending axially beyond the sidewalls 101. In some embodiments, the extensions 116 can form a labyrinth seal, to discourage hot gas ingestion from the mainstream airflow M.

While the description herein is written with respect to the turbine section, it should be understood that the concepts disclosed herein can have equal application to the compressor section, or any other section susceptible to leakage or gas ingestion or to a labyrinth seal adapted to prevent undesired movement of gas within an engine.

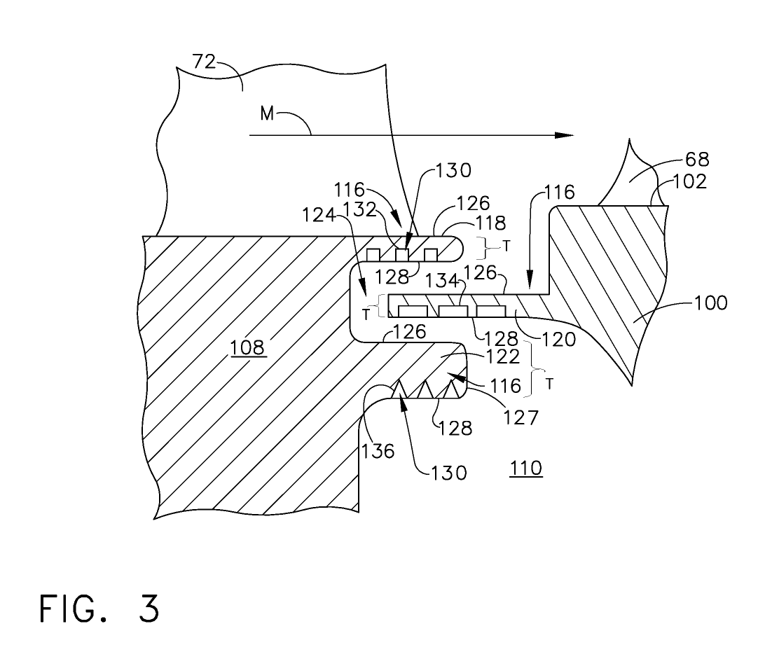

FIG. 3 is an enlarged view of three extensions 116, illustrated as a stationary outer discourager 118, an angel wing 120 extending from the dovetail 100, and a stationary inner discourager 122 extending from the ring 108 to form a labyrinth path 124 in the buffer cavity 110 between the rotor cavity and the mainstream airflow M. Each extension 116 can have a topside surface 126 and an underside surface 128, with the topside surface 126 facing the mainstream airflow M and the underside surface 128 facing the rotor cavity. Furthermore, each extension 116 can have a forward or aft surface 127, facing toward the adjacent component in the forward or aft direction. While the extensions 116 are illustrated as the inner and outer discouragers 118, 122, and the angel wing 120, it should be appreciated that the extension 116 can be any element extending into the buffer cavity between the rotating and non-rotating elements, such as the platform 102, in one non-limiting example. The angel wing 120 can have a thickness T. The thickness T can be the width of the angel wing 120 extending in a radial direction, or, alternatively, can be measured as the distance between the topside surface 126 and the underside surface 128 of the same extension 116. In another example, the thickness T can be the metal thickness of the angel wing 120 or extension 116. The thickness T can be similarly representative of any extension 116.

The extensions 116 can include one or more recesses 130. The recesses 130 can be non-hemispherical, in one non-limiting example, while any shape of the recesses are contemplated. In another example, the recesses 130 can include profiles that are square 132, rectangular 134, triangular 136, or any combination thereof. Such profiles can be representative of recesses 130 that are cubic or conical.

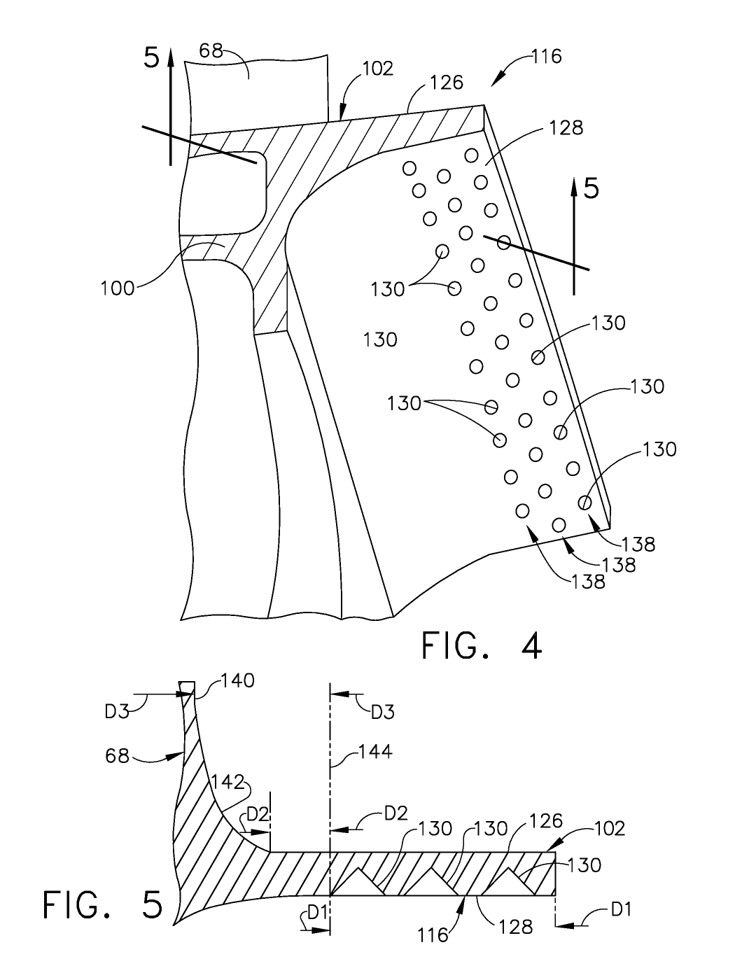

Referring now to FIG. 4, the recesses 130 can be organized along the underside surface 128 of the extension 116 shown as the platform 102 extending from the dovetail 100. The recesses 130 can be organized into rows 138. The rows 138, can be offset as shown, or can be patterned or organized in any manner. Any number of rows 138 are contemplated. While the recesses 130 are shown as having circular orientations, such as that of a conic or cylindrical geometry, the recesses 130 can be of any shape. For example, the recesses can be squared, triangular, geometric, curvilinear, or uniquely shaped, such as having larger or smaller portions, or having combinations of linear and non-linear portions. Such uniquely shaped recesses can be tailored based upon the particular extension 116 and the particular needs of the engine or component. The recesses 130 formed in the rows 138 can be all of a similar geometry, or can be a combination of different geometries. For example, one geometry may be advantageous to position near the end of the extension 116 as opposed to another geometry. Furthermore, differing geometries can be patterned or arranged among an array of recesses 130 formed as the rows 138.

Referring now to FIG. 5, taken across section 5-5 of FIG. 4, illustrates a triangular profile of conic recesses 130 provided on the platform 102, with the blade 68 having a trailing edge 140 and a fillet 142 transitioning between the platform 102 and the trailing edge 140. A radial axis 144 can be defined through or adjacent to one of the recesses 130. In one example, as shown, the radial axis 144 is defined at the edge of the recess nearest the blade 68, extending perpendicular to the engine centerline 12 (FIG. 1). The extension 116 as the platform 102, or any extension described herein, can have an extension length D1 measured as the longitudinal length of the extension 116 in the axial direction. The radial axis 144 can be spaced from the fillet 142 by a first distance D2 and the radial axis 144 can be spaced from the trailing edge 140 by a second distance D3. In a first non-limiting example, D2 can be defined as between 0% and 60% of the extension length D1. In another example, D2 can be defined as between 0% and 20% of the extension length D1. In another non-limiting example, D2 or D3 can be between zero and one-third of the length of the platform 102 or similar extension 116 downstream of the airfoil trailing edge 140. In yet another non-limiting example, D3 can be between zero and three-fourths of the length of the platform 102 D1. The first and second distances D2, D3, in one non-limiting example, can be measured in a direction parallel to the engine centerline 12 (FIG. 1), extending orthogonal to the radial axis 144. In another example, the first and second distances D2, D3 can be measured parallel to the local mainstream flow M. While the radial axis 144 is measured from the shortest distance from a recess 130 to the fillet 142 and the trailing edge 140, it should be appreciated that the radial axis 144 can be measured at any position of the recess 130, or from any one of the multiple recesses 130, such as along the axial center of the recess 130, the axial center of multiple recesses 130, the aft-most position of the recess 130, or the forward most portion, in non-limiting examples. Additionally, the distances D2, D3 can be measured as the shortest distance between the radial axis 144 and the plurality of trailing edges 140 or fillets 142 along a disk 71 having a plurality of blades or vanes. Furthermore, it should be appreciated that the distances D2, D3 can have equal applicability to a ring 108 or a set of vanes 72, as well as the leading edge of a blade 68 or a vane 72, or other similar airfoil component.

The recesses 130 provide for an increased heat transfer coefficient for the underside surface 128 increasing convective heat transfer of the extension 116 at the cold surface. Increasing the heat transfer along the underside surface 128 lowers the metal temperatures of the extensions 116 and provides for improved durability for the extensions 116. The improved heat transfer, lowered metal temperature, and increased durability of the extension 116 increases component lifetime and reducing required maintenance. Particularly, a platform having the topside surface 126 facing the heated mainstream airflow M sees an improvement to durability. Furthermore, the increased heat transfer coefficient provides for lower metal temperatures at the extension. The cooling benefit resulting from the recesses 130 can further be optimized with a purge flow cooling reduction, which would increase engine efficiency.

Additionally, the recesses 130 can increase the heat transfer along the underside surface 128 without increasing the effective clearance between adjacent extensions 116, or along the labyrinth path 124 (FIG. 3). Furthermore, the recesses can even decrease the effective radial clearance and an associated purge flow reduction resulting in improved engine efficiency. Alternatively, an extension 116 having an increased thickness T is permitted with the improved cooling of the underside surface 128. The extension 116 can have a tapered thickness T, such that the thickness T adjacent to the ring 108 or dovetail 100 as described herein is greater than the thickness at the axial, extended edge of the extension 116. The tapered thickness of the extension 116 provides for improved durability for the extension 116. Additionally, the improved heat transfer provides for a greater thickness T or tapered thickness for the extension 116 while having the same thermal heat transfer coefficient as an extension without the plurality of recesses for the same airflow passing though the turbine engine 10. The realized improvement is a result of the increased thermal conduction into the ring 108 or the dovetail 100. While the increased thickness T is described herein, it should be appreciated that the increased thickness T can be a greater effective dimension, such as a greater length extending in the axial direction, or any increase in volume of the extension that can be supported within the engine by the improved heat transfer coefficient. Such an increase in effective dimension can be relative to an extension having at least a same thermal heat transfer coefficient without the plurality of recesses for the same working air flow within the engine 10 (FIG. 1).

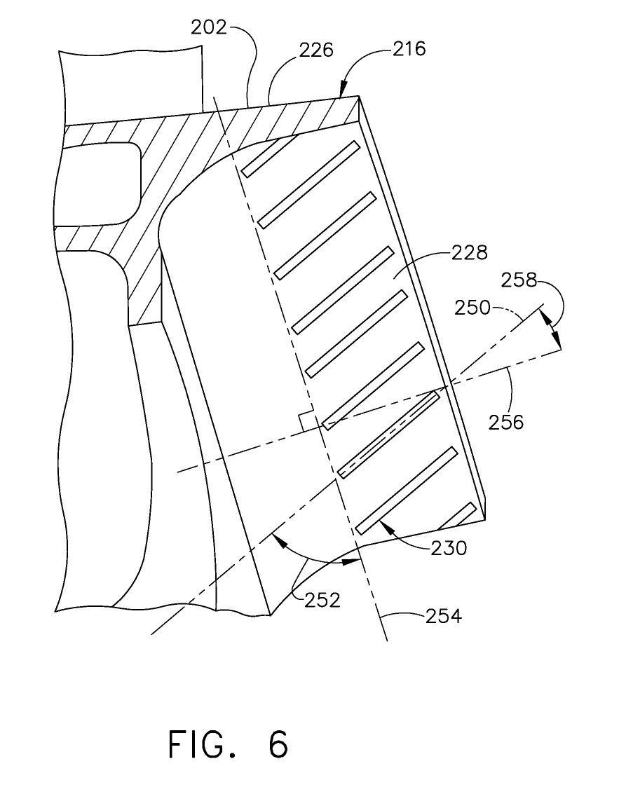

Referring now to FIG. 6 another exemplary extension 216 is illustrated as a platform 202. FIG. 6 can be substantially similar to FIG. 4. As such, similar numerals will be used to describe similar elements increased by a value of one hundred. A plurality of elongated recesses 230 are provided on an underside surface 228 of the extension 216. The recesses 230 are shaped as elongated troughs. While the trough recesses 230 are illustrated as linear, it should be appreciated that they can be non-linear or a portion of the trough recess 230 can be non-linear. The geometry and spacing of the trough recess 230 can vary extending around the centerline axis 256 or the circumferential axis 254. While the extension 216 is shown as a platform 202, it should be appreciated that the extension 116 is not limited to the platform 202 and can be other extensions such as an angel wing or discourager in non-limiting examples. A profile for the recesses 230 can be semicircular in one non-limiting example, such that the recess 230 is formed as half of a cylinder-shape in the underside 228 of the extension 116. Additional profiles for the recess 230 in non-limiting examples can include square, rectangular, triangular, or unique.

The recesses 230 can be oriented at an angle. The recesses 230 can define a longitudinal axis 250 extending along the longitudinal length of the recess 230. The recesses 230 can be angled at a first angle 252 relative to a circumferential axis 254 defined in the circumferential direction relative to the engine centerline 12 (FIG. 1) along the extension 216. As the extension 216 rotates with rotation of a rotor 171, the recesses 230 can be angled into the direction of rotation, such that the first angle 252 is less than 90-degrees. Alternatively, the trough recesses 230 can be angled away from the direction of rotation, such that the first angle 252 is less than 90-degrees, taken in the opposite direction.

Additionally, the trough recesses 230 can be oriented at a second angle 258 relative to a centerline axis 256. The centerline axis 256 can be a projection of the engine centerline 12 (FIG. 1) onto the extension 216, extending in the forward and aft directions. The second angle 258 can be between 0-degrees and 90-degrees, with the recess 230 being angled into or away from the direction of rotation.

It should be appreciated that the circumferential axis 254 can be orthogonal to the centerline axis 256 anywhere the centerline axis 256 is projected onto the extension 216. It should be understood that the recesses 230 can be oriented at both the first and second angles 252, 258, being relative to two axes 254, 256 simultaneously. The recesses 230 can be optimized based upon the first or second angles 252, 258 to maximize the heat transfer coefficient of the underside surface 228 of the extension 216. Such optimization can include varying orientation of the recesses 230 by varying the first or second angles 252, 258. Additionally, the length of the trough recesses 230 along the longitudinal axis 250, as well as the width, depth, profile, or shape of the trough recess 230 can be varied to maximize the heat transfer coefficient of the underside surface 228 of the extension 216.

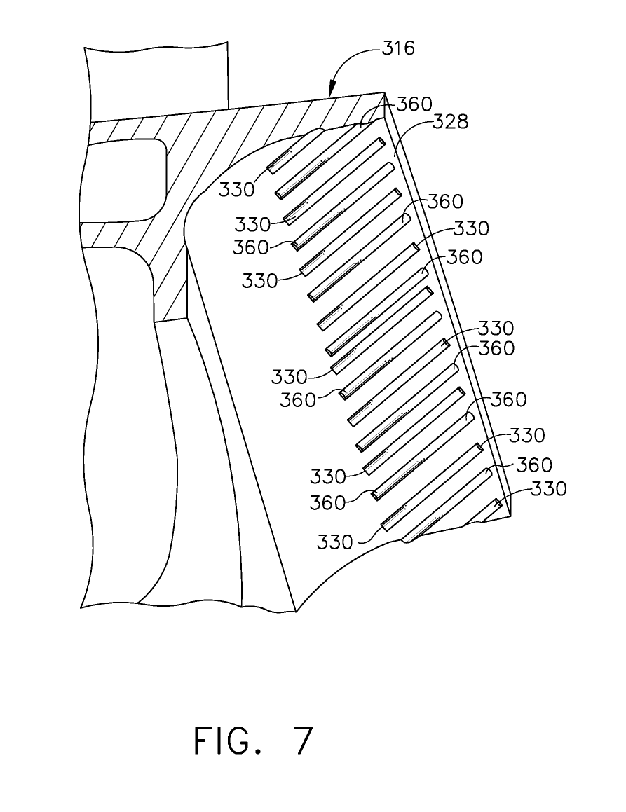

Referring now to FIG. 7, a plurality of turbulators 360 can be provided on an underside 328 of the extension 316 in addition to the recesses 330. FIG. 7 can be substantially similar to that of FIG. 6. As such, similar numerals will be used to identify similar elements increased by a value of one hundred and the discussion will be limited to differences between FIG. 6 and FIG. 7.

Turbulators 360 are included on the underside surface 328 between adjacent recesses 330 to form a pattern of alternating turbulators 360 and recesses 330 organized circumferentially about the extension 316. The turbulators 360, in one example, can have the same length as the recesses 330. Similarly, the turbulators 360 can have the same shape as the trough recesses 330, extending out of the underside surface 328 as opposed to recessed into the underside surface 328. As such, there will be no net gain of material along the extension 316, with no weight gain to the engine. Alternatively, the turbulators 360 can be smaller than the recesses 330, such that a net decrease in engine weight is appreciated as compared to an extension without any recesses or turbulators.

Furthermore, there can be more or less turbulators 360 or recesses 330 than as shown. For example, there can be three recesses 330 for every one turbulator 360, or, alternatively, three turbulators 360 for every recess 330. As such, the organization and number of turbulators 360 and recesses 330 can be optimized to maximize the heat transfer coefficient on the underside surface 328 of the extension 316. As such, the geometry and spacing of the turbulators 360 or recesses 330 can vary extending around the centerline axis 356 or the circumferential axis 354.

Further still, the turbulators 360 need not be limited as shown. The turbulators 360 can be any shape or size, such as individual hemispherical turbulators organized into rows and integrated into the recesses 130 of FIG. 4 or turbulators having the same shape as the recesses 130 of FIG. 4. In another example, rectangular turbulators, having a square profile, could be integrated between individual sets of recesses 130 of FIG. 4. In yet another example, discrete individual cube-shaped turbulators, organized into discrete rows, could be positioned between the trough recesses 230 of FIG. 6. It should be appreciated that any there are numerous combinations of recesses and turbulators, based upon variable lengths, widths, sizes, volumes, profiles, quantities, locations, or organizations thereof. Such factors can be adapted to maximize or tailor the heat transfer coefficient along the extension to the needs of the particular engine or component. Tailoring the heat transfer coefficient can include providing more or less recesses or turbulators at particular locations along the extension, where greater or lesser heat transfer is required. Additionally, said factors can be balanced with other factors, such as engine weight or required clearance distances within the buffer cavity at the extensions, in order to minimize weight, maintain or reduce clearance distances, while maximizing the local heat transfer coefficients based upon the usage of recesses or recesses and turbulators. As such, engine efficiency and weight can be improved or maintained while balancing local heat transfer needs.

It should be appreciated that the height of the turbulators 360 increases the required clearance distance between the extension 316 and an adjacent component, such as another extension, in order to maintain the required clearance between rotating and non-rotating components in the buffer cavity. Thus, it should be appreciated that that usage of the recesses as described herein can improve the underside heat transfer coefficient of a particular extension without increasing the required clearance distance between adjacent components. Such an improvement in local heat transfer can even decrease the required purge flow preventing the hot gas ingestion and improving engine efficiency.

A method of lowering metal temperatures of an extension extending into a buffer cavity between a rotor and a stator of a turbine engine can include providing a plurality of recesses on an underside of the extension. The recesses increase the heat transfer coefficient on the underside of the extension while maintaining or minimizing a required effective clearance between the extension of an adjacent surface. The extension can be an angel wing, discourager, or a platform as described herein, for example. The recesses can be the elongated trough-shaped recesses of FIG. 6, for example, or can be multiple non-hemispherical recesses as described in FIGS. 4-5. Additionally, the method can further include providing a plurality of turbulators on the underside of the extension, in addition to the recesses. Organization of recesses and turbulators can be as described herein, in any organization or combination. Additionally, providing the plurality of recesses on the underside of the extension can provide for an increased thickness of the extension, which can provide for improved durability and lifetime of the extension, or the component to which is couples. The improved durability can improve operational time-on-wing, reducing required maintenance and cost.

It appreciated that recesses as described herein provide for increasing the cool side local heat transfer coefficient for an extension into a buffer cavity between a rotor and a stator. The increased heat transfer coefficient lowers metal temperatures of the extension, improves durability and can improve engine efficiency. In particular, the recesses as provided on a platform extending from a rotor adjacent to a heated mainstream flow can see a significant reduction in metal temperatures and improvements to durability. The recess geometry allows for minimal impact to the clearance gap between the rotating and non-rotating components and can even provide for decreasing the required clearance. Thus, an improvement to component durability, heat transfer, time-on-wing, cost, and required maintenance can be appreciated while maintaining critical effective clearances between the rotor and stator extensions.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A disk assembly for a turbine engine defining an engine centerline extending axially between a forward end and an aft end of the turbine engine, the disk assembly comprising:
a disk rotatable about the engine centerline having disk sidewalls and having a platform as a radially exterior surface of the disk with the platform having an extension with an underside and extending axially beyond at least one disk sidewall; and
a plurality of recesses formed on the underside of the extension.

2. The disk assembly of claim 1 further comprising a plurality of blades mounted circumferentially about the disk at the platform.

3. The disk assembly of claim 1 wherein the disk further includes a dovetail having a dovetail sidewall and the extension includes a fillet extending from the extension to the sidewall of the dovetail.

4. The disk assembly of claim 1 further comprising an angel wing extending from the disk radially within the platform.

5. The disk assembly of claim 1 wherein the extension defines an extension length in an axial direction.

6. The disk assembly of claim 5 wherein the plurality of recesses are spaced from the sidewall of the disk at the platform by between 0% and 60% of the extension length.

7. The disk assembly of claim 6 wherein the plurality of recesses are spaced from the sidewall of the disk by between 0% and 20% of the extension length.

8. The disk assembly of claim 1 wherein the plurality of recesses are formed as elongated troughs.

9. The disk assembly of claim 8 wherein the elongated troughs are oriented at an angle relative to a projection of the engine centerline onto the extension.

10. A turbine engine having a working air flow comprising:
a stator having a first working surface over which the working air flow passes;
a rotor rotating relative to the stator being spaced from the stator defining a buffer cavity and having a second working surface over which the working air flow passes.
a disk forming at least a portion of the rotor and including a plurality of circumferentially arranged blades mount to a platform having an extension extending over the buffer cavity with the extension having an underside; and
a plurality of recesses formed on the underside of the platform.

11. The turbine engine of claim 10 wherein the plurality of recesses are a plurality of elongated recesses.

12. The turbine engine of claim 10 wherein the blades included a fillet at the platform and the plurality of recesses and wherein the extension defines an extension length in an axial direction.

13. The turbine engine of claim 12 wherein the plurality of recesses are spaced from the fillet at the platform by between 0% and 60% of the extension length.

14. The turbine engine of claim 13 wherein the plurality of recesses are spaced from the fillet by between 0% and 20% of the extension length.

15. The turbine engine of claim 10 further comprising a plurality of turbulators provided on the extension, wherein the turbulators are positioned between adjacent recesses.

16. A method of lowering metal temperatures of an extension extending into a buffer cavity between a rotor and a stator of a turbine engine, the method comprising:
providing a plurality of recesses on an underside of the extension;
wherein the recesses increase a heat transfer coefficient on the underside of the extension while maintaining or minimizing a required effective clearance between the extension and an adjacent surface.

17. The method of claim 16 wherein the extension is one of an angel wing or a discourager.

18. The method of claim 16 wherein the extension is a platform of the rotor to which a plurality of blades mount.

19. The method of claim 16 further comprising providing a plurality of turbulators on the underside of the extension.

20. The method of claim 16 wherein the recess is an elongated recess.

21. The method of claim 16 wherein the increased heat transfer coefficient provides for increasing durability of the extension.
